(19) United States
(12) Patent Application Publication
(10) Pub. No.: US 2025/0309554 A1
(43) Pub. Date: Oct. 2, 2025

(54) INTELLIGENT REFLECTING SURFACE

(71) Applicant: Japan Display Inc., Tokyo (JP)

(72) Inventors: Mitsutaka OKITA, Tokyo (JP); Shinichiro OKA, Tokyo (JP); Daiichi SUZUKI, Tokyo (JP); Kazuki MATSUNAGA, Tokyo (JP)

(73) Assignee: Japan Display Inc., Tokyo (JP)

(21) Appl. No.: 19/237,080

(22) Filed: Jun. 13, 2025

Related U.S. Application Data
(63) Continuation of application No. PCT/JP2023/041271, filed on Nov. 16, 2023.

(30) Foreign Application Priority Data
Dec. 14, 2022 (JP) 2022-199313

(51) Int. Cl. H01Q 15/14

(52) U.S. Cl. CPC H01Q 15/148

(57) ABSTRACT

An intelligent reflecting surface includes a first substrate including a patch electrode, a strip wiring connected to the patch electrode, and a transistor electrically connected to the strip wiring, a second substrate including a counter electrode opposite the patch electrode, and a liquid crystal layer between the first substrate and the second substrate. The strip wiring includes a first linear portion in the same direction as an oscillation direction of a polarized wave incident on the patch electrode, and a second linear portion intersecting the oscillation direction of the polarized wave.

### CROSS-REFERENCE TO RELATED APPLICATIONS

This application is a Continuation of International Patent Application No. PCT/JP2023/041271, filed on Nov. 16, 2023, which claims the benefit of priority to Japanese Patent Application No. 2022-199313, filed on Dec. 14, 2022, the entire contents of each are incorporated herein by reference.

### FIELD

An embodiment of the present invention relates to the structure of a radio wave reflecting device using a liquid crystal. In the following description, the radio wave reflecting device is referred to as “Intelligent Reflecting Surface” or “IRS”.

### BACKGROUND

A phased array antenna controls the directivity of an antenna by adjusting the amplitude and phase of a high-frequency signal applied to each of a plurality of antenna elements arranged in a plane shape. Phased array antennas use phase shifters to control the phase of high frequency signals. As an example, Japanese laid-open patent publication No. H11-103201 discloses a phased array antenna device using a phase shifter utilizing a phenomenon in which the dielectric constant of a liquid crystal changes with an applied voltage.

According to Japanese laid-open patent publication No. 2019-530387, an intelligent reflecting surface which controls the reflection direction of radio waves using liquid crystal as well as a phased array antenna is known. For example, an intelligent reflecting surface is disclosed in which a meta surface reflecting radio waves is formed by a microstrip patch array sandwiching a liquid crystal layer.

The intelligent reflecting surface disclosed in Japanese laid-open patent publication No. 2019-530387 is a structure in which a liquid crystal layer is provided between a patch electrode and a counter electrode. The direction in which the intelligent reflecting surface reflects radio waves is controlled by the voltage applied to the patch electrodes. Strip wiring is connected to the patch electrode to apply a bias voltage. However, it is anticipated that the reflection characteristics may be reduced by connecting the strip wiring to the patch electrode.

### SUMMARY

An intelligent reflecting surface in an embodiment according to the present invention includes a first substrate including a patch electrode, a strip wiring connected to the patch electrode, and a transistor electrically connected to the strip wiring, a second substrate including a counter electrode opposite the patch electrode, and a liquid crystal layer between the first substrate and the second substrate. The strip wiring includes a first linear portion in the same direction as an oscillation direction of a polarized wave incident on the patch electrode, and a second linear portion intersecting the oscillation direction of the polarized wave.

### BRIEF DESCRIPTION OF DRAWINGS

FIG. 1A is a plan view showing a unit cell constituting an intelligent reflecting surface according to an embodiment of the present invention.

FIG. 1B is a cross-sectional view showing a unit cell constituting an intelligent reflecting surface according to an embodiment of the present invention.

FIG. 2 is a plan view showing a unit cell constituting an intelligent reflecting surface according to an embodiment of the present invention.

FIG. 3 is a plan view showing a configuration of an intelligent reflecting surface according to an embodiment of the present invention.

FIG. 4 is a plan view showing a unit cell constituting an intelligent reflecting surface according to an embodiment of the present invention.

FIG. 5 is a plan view showing a configuration of an intelligent reflecting surface according to an embodiment of the present invention.

FIG. 6 is a cross-sectional view showing a configuration of an intelligent reflecting surface according to an embodiment of the present invention.

FIG. 7 is a plan view showing the structure of a unit cell in which the connecting positions of strip wiring are different.

### DESCRIPTION OF EMBODIMENTS

Hereinafter, embodiments of the present invention are described with reference to the drawings. However, the present invention can be implemented in many different aspects and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to previous drawings may be given the same reference sign (or a number followed by a, b, etc.) and a detailed description may be omitted as appropriate. The terms “first” and “second” appended to each element are convenient terms used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

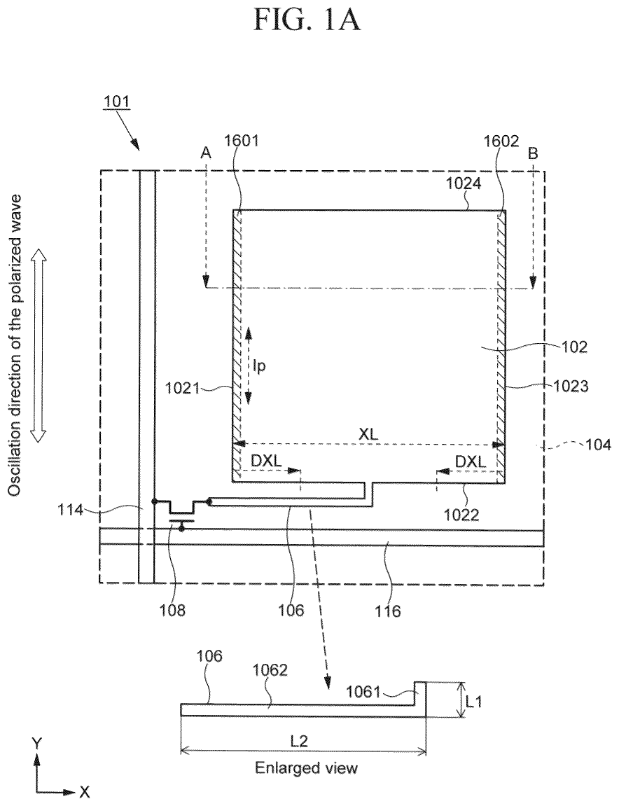

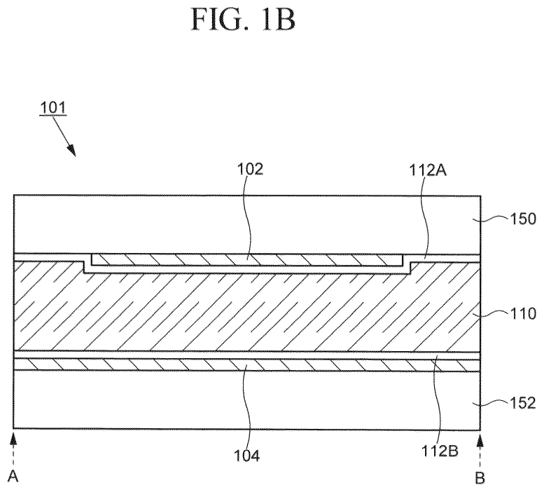

FIG. 1A is a plan view of the unit cell 101 constituting the intelligent reflecting surface according to the present embodiment when viewed from the front (radio wave incident surface). FIG. 1B shows a longitudinal cross-sectional view corresponding to the line A-B shown in FIG. 1A.

As shown in FIG. 1A and FIG. 1B, the unit cell 101 includes a patch electrode 102, a counter electrode 104 (also referred to as a “ground electrode”) arranged on a rear surface of the patch electrode 102, a liquid crystal layer 110 between the patch electrode 102 and the counter electrode 104, and a transistor 108. The patch electrode 102 is arranged on the first substrate 150, and the counter electrode 104 is arranged on the second substrate 152. A first alignment film 112A is arranged on the first substrate 150 to cover the patch electrode 102, and a second alignment film 112B is arranged on the second substrate 152 to cover the counter electrode 104.

The first substrate 150 and the second substrate 152 are arranged so that the patch electrode 102 and the counter electrode 104 face each other and have a gap between them. The liquid crystal layer 110 is arranged to fill the gap between the first substrate 150 and the second substrate 152. The transistor 108 is connected to a control signal line 114 and a selection signal line 116 arranged on the first substrate 150.

Although not shown in FIG. 1B, the first substrate 150 and the second substrate 152 are attached by a sealing material. The distance (cell gap) between the first substrate 150 and the second substrate 152 is 20 to 100 μm, and has, for example, a distance (cell gap) of 50 μm. Spacers may be arranged between the first substrate 150 and the second substrate 152 to keep the gap constant.

FIG. 1A shows an example in which the patch electrode 102 is square. The shape of the patch electrode 102 in a plan view is not limited, and may be a rectangle, a circle, an ellipse, or a polygon having more angles than a rectangle. For example, the patch electrode 102 may have a shape in which a part of the rectangular corners is cut off.

As shown in FIG. 1A, the patch electrode 102 has a first side 1021 and a third side 1023 in the same direction as the first direction (in other words, parallel or substantially parallel directions), and a second side 1022 and a fourth side 1024 in the same direction as the second direction (in other words, parallel or substantially parallel directions). The length of these sides is appropriately adjusted according to the frequency (wavelength) of the radio wave applied to the intelligent reflecting surface. The shape of the patch electrode 102 is not limited to a square, and the lengths of the first side 1021 and the third side 1023 may differ from the lengths of the second side 1022 and the fourth side 1024 for the purpose of fine-tuning the reflection characteristics.

For convenience of explanation, the first direction refers to a direction along the Y axis shown in FIG. 1A, and the second direction refers to a direction along the X axis shown in FIG. 1A. Therefore, the first direction and the second direction intersect (preferably orthogonally or substantially orthogonally).

The counter electrode 104 has a larger area than the patch electrode 102. Materials for forming the patch electrode 102 and the counter electrode 104 are not limited, and metals, alloys, and conductive metal compounds (for example, metal oxides having conductivity) can be used.

The control signal line 114 extends in the first direction, and the selection signal line 116 extends in the second direction. The transistor 108 is arranged in the vicinity of the intersection of the control signal line 114 and the selection signal line 116. The transistor 108 is, for example, a thin film transistor. The structure of the transistor 108 is not limited, and various structures such as a top gate type and a bottom gate type can be applied. The transistor 108 is shown with a circuit symbol in FIG. 1A.

The transistor 108 includes a control terminal (gate), a first input/output terminal (one of the source and drain), and a second input/output terminal (the other of the source and drain). The control terminal (gate) of the transistor 108 is electrically connected to the selection signal line 116, the first terminal (one of the source and drain) is electrically connected to the control signal line 114, and the second terminal (the other of the source and drain) is electrically connected to the strip wiring 106.

When one or the other of the source and drain is referred to, when one corresponds to the source, the other corresponds to the drain, and when one corresponds to the drain, the other corresponds to the source.

The strip wiring 106 is formed of a narrow conductive pattern extending from the patch electrode 102. FIG. 1A shows a structure in which one end of the strip wiring 106 is connected to the second side 1022 of the patch electrode 102 and the other end is connected to the transistor 108. As shown in the enlarged view inserted in FIG. 1A, the strip wiring 106 includes a first linear portion 1061 extending in the first direction from the portion connected with the patch electrode 102 and a second linear portion 1062 extending in the second direction from the first linear portion 1061. The first linear portion 1061 and the second linear portion 1062 are continuous conductive patterns. The end of the first linear portion 1061 of the strip wiring 106 is connected to the second side 1022 of the patch electrode 102, and the end of the second linear portion 1062 is electrically connected to the transistor 108. The length of the strip wiring 106 is not limited, and it is preferable to have a length that is ½ or ¼ times the wavelength of the reflected radio wave. When the length of the first linear portion 1061 of the strip wiring 106 is L1 and the length of the second linear portion 1062 is L2, the length L2 of the second linear portion 1062 is longer than the length L1 of the first linear portion 1061.

A control signal for controlling the orientation state of the liquid crystal molecules in the liquid crystal layer 110 is applied to the control signal line 114, and a selection signal for turning the transistor 108 on and off is applied to the selection signal line 116. When the transistor 108 is turned on by the selection signal of the selection signal line 116, a predetermined voltage based on the control signal is applied from the control signal line 114 to the patch electrode 102 via the transistor 108.

The control signal applied to the patch electrode 102 is a DC voltage signal or a polarity reversal signal in which a positive DC voltage and a negative DC voltage are alternately reversed. The counter electrode 104 is grounded or applied with a voltage at an intermediate level of the polarity reversal signal. When a control signal is applied to the patch electrode 102, the orientation state of the liquid crystal molecules contained in the liquid crystal layer 110 changes. A liquid crystal material having dielectric anisotropy is used for the liquid crystal layer 110. For example, nematic liquid crystal, smectic liquid crystal, cholesteric liquid crystal and discotic liquid crystal are used as the liquid crystal layer 110.

Since the liquid crystal layer 110 has anisotropy of a dielectric constant, the dielectric constant changes according to the orientation state of the liquid crystal molecules. The intelligent reflecting surface individually changes the dielectric constant of the liquid crystal layer 110 by a control signal applied to a plurality of patch electrodes 102 arranged in a matrix, thereby changing the phase of the reflected wave and controlling the traveling direction of the reflected wave.

The intelligent reflecting surface reflects radio waves in the Very High Frequency (VHF), Ultra-High Frequency (UHF), Super High Frequency (SHF), Tremendously High Frequency (THF), Extra High Frequency (EHF), and Terahertz bands. The liquid crystal molecules of the liquid crystal layer 110 change their orientation state in response to a control signal applied to the patch electrode 102. However, the liquid crystal molecules hardly follow the frequency of the radio waves incident on the patch electrode 102. Thus, the intelligent reflecting surface can control the direction of the reflected wave without being affected by radio waves.

As will be described later, the intelligent reflecting surface has a structure in which the unit cells 101 are arranged in a matrix and has a function of reflecting linearly polarized waves (vertically polarized waves and horizontally polarized waves) and circularly polarized waves and controlling the traveling direction of the reflected waves. FIG. 1A shows a case (a case of vertically polarized waves) in which the direction of oscillation of the incident linearly polarized wave is the same as the first direction (in other words, a direction parallel or substantially parallel). As shown in FIG. 1A, the first side 1021 and the third side 1023 of the patch electrode 102 extend along the same direction with respect to the oscillation direction of the vertically polarized wave (in other words, parallel or substantially parallel), and the second side 1022 and the fourth side 1024 intersect (preferably orthogonally or substantially orthogonally). The strip wiring 106 has the first linear portion 1061 in the same direction as the oscillation direction of the vertically polarized wave (in other words, parallel or substantially parallel), and the second linear portion 1062 intersects the oscillation direction of the vertically polarized wave (preferably, orthogonally or substantially orthogonally).

As shown in FIG. 1A, when a vertically polarized wave is incident on the patch electrode 102, it is known that the density of the current generated in the patch electrode 102 is in the same direction as the oscillation direction of the vertically polarized wave and becomes high near the end of the patch electrode 102 (area along the first side 1021 and the third side 1023). When the oscillation direction of the vertically polarized wave is the same as the first direction (in other words, parallel or substantially parallel directions), the current density of the first side 1021 and the third side 1023 of patch electrode 102 is higher than that of the other areas. FIG. 1A schematically shows a state in which areas 1601, 1602 with high current density are generated near the first side 1021 and the third side 1023. The current Ip flows in the same direction as the first direction (in other words, in a parallel or substantially parallel direction) in the areas 1601, 1602 with high current density.

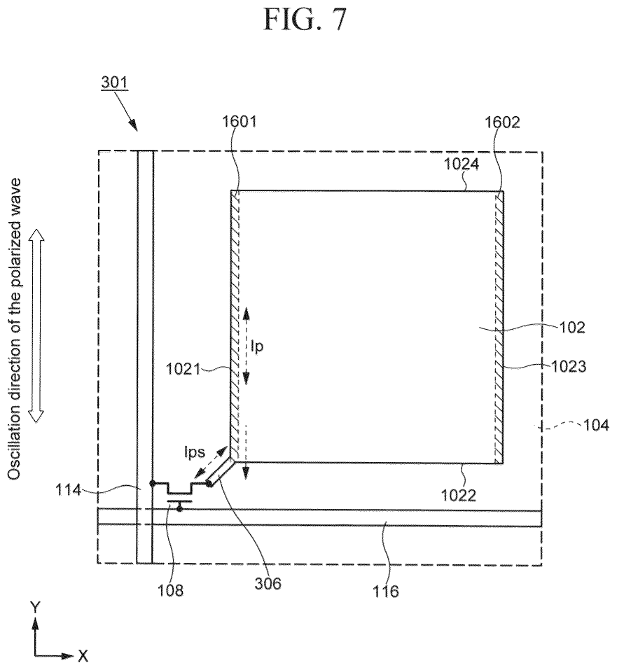

FIG. 7 shows a reference example of a unit cell 301, and shows an example in which the structure and connection position of a strip wiring 306 are different from the unit cell 101 shown in FIG. 1A. The unit cell 301 has the strip wiring 306 connected to a corner portion where the first side 1021 and the second side 1022 of the patch electrode 102 intersect and is connected to the transistor 108 by extending obliquely. That is, the strip wiring 306 extends in the direction of the transistor 108 at an angle of 45 degrees from the corner portion of the patch electrode 102.

When a vertically polarized wave is incident on such unit cells 301, the areas 1601, 1602 with high current density are generated in the vicinity of the ends along the first side 1021 and the third side 1023 of the patch electrode 102, similar to the example shown in FIG. 1A. The strip wiring 306 is connected directly to the area 1601 with high current density in the patch electrode 102. Therefore, the current Ip in the area 1601 with high current density flows into the strip wiring 306. As a result, the intensity of the reflected vertically polarized wave decreases with respect to the vertically polarized wave incident on the unit cell 301. The current Ips flowing through the strip wiring 306 can be divided into components in the same direction as the first direction (in other words, parallel or substantially parallel) and components in the same direction as the second direction (in other words, parallel or substantially parallel directions). The presence of a current component in the same direction as the second direction (in other words, parallel or substantially parallel directions) means that a horizontally polarized wave is included in the reflected wave. As a result, the difference between the vertically polarized wave (main polarized wave) and the horizontally polarized wave (cross polarized wave) is decreased, and a good reflection characteristic cannot be obtained.

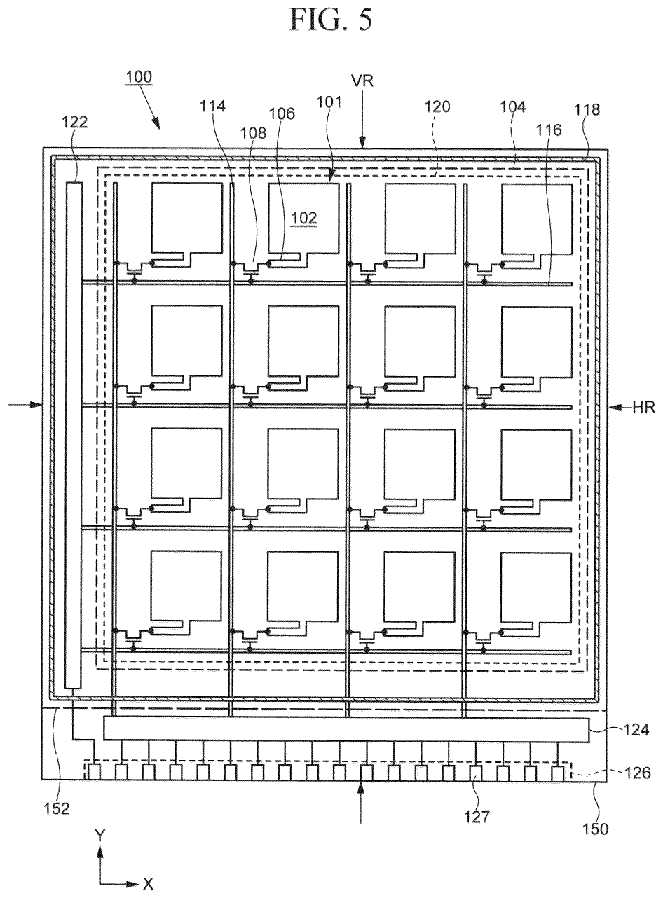

Table 1 shows the power difference between the received power of the main polarized wave and the received power of the cross polarized wave with respect to the liquid crystal applied voltage of the intelligent reflecting surface configured by the unit cells 101 according to the present embodiment as shown in FIG. 1A (the connection of the strip wiring is at the center of one side of the patch electrode) and the intelligent reflecting surface configured by the unit cells 301 shown as a reference example in FIG. 5. The intelligent reflecting surface shown in FIG. 5 has a structure in which the connecting portion of the strip wiring is arranged at the end of the patch electrode. In Table 1, the liquid crystal applied voltage V0 is 0 V, and V1 is higher than V0. The measurement was made by irradiating the intelligent reflecting surface with radio waves and detecting the intensity of the reflected waves with a receiver. The intelligent reflecting surface composed of the unit cell 301 is observed to have a tendency to have a smaller difference in a main polarized wave and cross polarized wave reception power depending on the liquid crystal applied voltage. It is considered that this is caused by an increase in the reception power of unnecessary cross polarized waves depending on the liquid crystal applied voltage, and it is understood that the reflection characteristic of the intelligent reflecting surface deteriorates. On the other hand, in the case of the intelligent reflecting surface composed of the unit cells 101, no significant change was observed in the difference between the main polarized wave and the cross polarized wave reception power regardless of the liquid crystal applied voltage. It is considered that this is because the generation of unnecessary cross polarized waves is prevented, and it is understood that good reflection characteristics are obtained.

TABLE 1

| | Difference in received power between main | |
|---|---|---|
| | polarization and cross polarization (dB) | |
| | Center | End (Reference example) |
| Applied voltage to | 32 | 16 |
| liquid crystal: V0 | | |
| Applied voltage to | 28 | 0.7 |
| liquid crystal: V1 | | |

The unit cell 101 shown in FIG. 1A has a connection portion of the strip wiring 106 near the center of the second side 1022 of the patch electrode 102 and is arranged at a position where a current does not flow directly from the areas 1601, 1602 with high current density. Table 1 shows that by having such a structure, it is possible to prevent a decrease in the current generated by the vertically polarized wave, suppress attenuation of the incident vertically polarized wave, increase the difference between the vertically polarized wave (main polarized wave) and the horizontally polarized wave (cross polarized wave), and obtain good reflection characteristics.

The connection portion between the patch electrode 102 and the strip wiring 106 is preferably located at a position away from the areas 1601, 1602 with high current density and at the center of the second side 1022 of the patch electrode 102. The same effect can be expected even when the connection position of the strip wiring 106 is slightly distant from the center of the second side 1022 of the patch electrode 102. That is, it is possible to expect the same effect when the second side 1022 of the patch electrode 102 is separated from the end of the side by the length DXL. In other words, it is preferable that the strip wiring 106 is connected near the center of one side of the patch electrode 102 that intersects (preferably orthogonally or substantially orthogonally) the direction of polarization (main polarized wave) of the radio wave. Here, the length DXL is preferably about ¼ to ⅕ of the total length XL of the second side 1022 of the patch electrode 102.

As shown in FIG. 1A, when a vertically polarized wave is incident on the patch electrode 102, the attenuation of the reflected vertically polarized wave can be prevented by connecting the strip wiring 106 to the second side 1022 intersecting the oscillation direction of the vertically polarized wave. In other words, when a linearly polarized wave is incident on the patch electrode 102, it is possible to prevent a current generated in the vicinity of a side in the same direction (in other words, parallel or substantially parallel direction) as the oscillation direction of the linearly polarized wave of the patch electrode 102 from flowing into the strip wiring 106 by connecting the strip wiring 106 at a position away from the end of one side intersecting the oscillation direction of the linearly polarized wave.

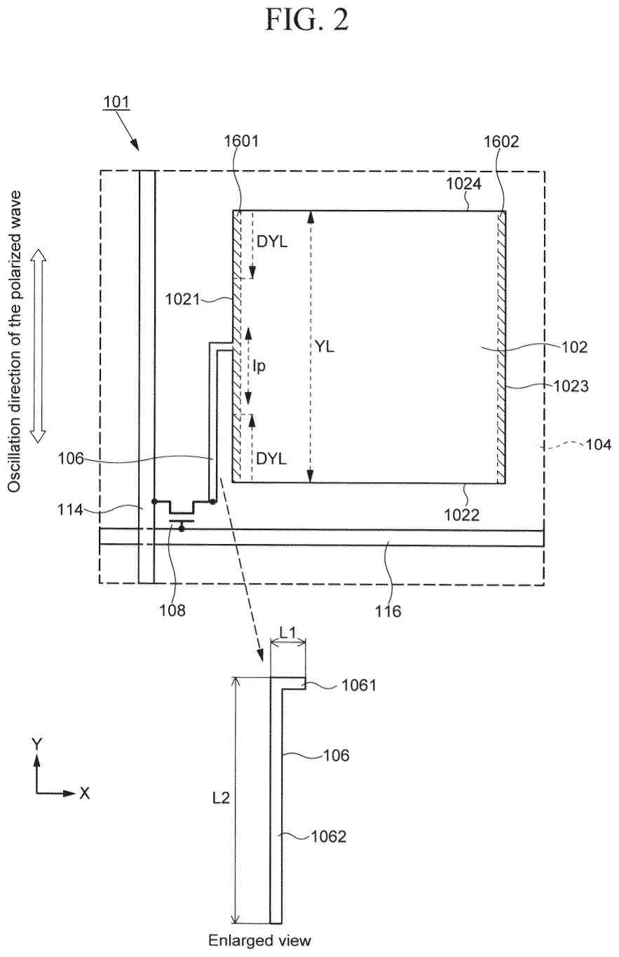

FIG. 2 shows an example of the unit cell 101 having a different connection position of the strip wiring 106 with respect to the configuration shown in FIG. 1A. FIG. 2 shows, similar to the example shown in FIG. 1A, that the oscillation direction of the vertically polarized wave is in the same direction as the first direction (in other words, in a parallel or substantially parallel direction), and that the strip wiring 106 is connected to the first side 1021 in the same direction as the oscillation direction of the vertically polarized wave (in other words, in a parallel or substantially parallel direction). As shown in the enlarged view inserted in FIG. 2, the strip wiring 106 includes a first linear portion 1061 extending in the second direction from the portion connected with the patch electrode 102 and a second linear portion 1062 extending in the first direction from the first linear portion 1061. The end of the first linear portion 1061 of the strip wiring 106 is connected to the first side 1021 of the patch electrode 102, and the end of the second linear portion 1062 is electrically connected to the transistor 108. When the length of the first linear portion 1061 of the strip wiring 106 is L1 and the length of the second linear portion 1062 is L2, L1 is shorter than L2. The length of the strip wiring 106 is not limited, and it is preferable to have a length that is ½ or ¼ times the wavelength of the reflected radio wave. The connection position between the strip wiring 106 and the first side 1021 of the patch electrode 102 is preferably located at a distance DYL from the end of the first side 1021, and the length DYL is preferably about ¼ to ⅕ of the total length YL of the first side 1021 of the patch electrode 102.

As shown in FIG. 2, when a vertically polarized wave is incident on the patch electrode 102, an area of high current density is generated near the first side 1021 and the third side 1023. The strip wiring 106 has a first linear portion 1061 extending in the second direction, while the current Ip in the area 1601 with high current density flows in the first direction. The strip wiring 106 is connected to the area 1603 with high current density, but since the current Ip flows in the first direction, the current flowing into the first linear portion 1061 extending in the second direction is reduced. Even if a small amount of current flows into the strip wiring 106 from the area 1601 with high current density, since the first linear portion 1061 intersecting the first direction is short and the second linear portion 1062 extending in the same direction (in other words, parallel or substantially parallel directions) as the first direction is long, the influence of the horizontally polarized wave (cross-polarized wave) on the vertically polarized wave (main polarized wave) is reduced, and good reflection characteristics can be obtained.

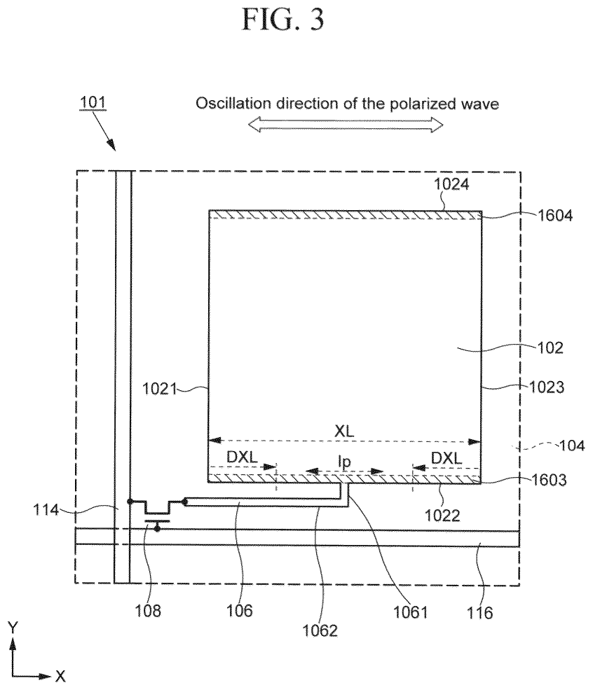

FIG. 3 shows a case in which a horizontally polarized wave is incident as a main polarized wave in a configuration similar to that of the unit cell 101 shown in FIG. 1A. That is, a case is shown where the oscillation direction of the polarized wave incident on the patch electrode 102 is in the same direction as the second direction (in other words, parallel or substantially parallel direction). In this case, the areas 1603, 1604 with high current density occur near the second side 1022 and the fourth side 1024 of the patch electrode 102.

The strip wiring 106 is connected near the center of the second side 1022 of the patch electrode 102. As shown in FIG. 3, while the first linear portion 1061 of the strip wiring 106 extends in the first direction, the current Ip in the area 1603 with high current density flows in the second direction. Similar to the example shown in FIG. 2, the strip wiring 106 is connected to the area 1603 with high current density, however, since the current Ip flows in the second direction, the current flowing in the first linear portion 1061 is reduced.

As shown in FIG. 3, the reduction of the current generated in the patch electrode 102 due to the incidence of the polarized wave can also be prevented by connecting the strip wiring 106 which forms a current path in a direction intersecting (preferably orthogonally or substantially orthogonally) the direction of oscillation of the polarized wave to the center portion of one side in the same direction (in other words, parallel or substantially parallel) as the direction of oscillation of the polarized wave. Even if a current flows into the strip wiring 106, since the second linear portion 1062 is longer than the first linear portion 1061 and extends in the same direction as the second direction (in other words, parallel or substantially parallel directions), and the current flows in the same direction as the current Ip flowing through the patch electrode 102 (in other words, parallel or substantially parallel directions), the effect of suppressing attenuation of the reflected horizontally polarized wave can be expected.

Although not shown, when the strip wiring 106 is connected to the first side 1021 in the configuration shown in FIG. 3, the configuration is similar to that described with reference to FIG. 1A, and the same operation and effect can be obtained.

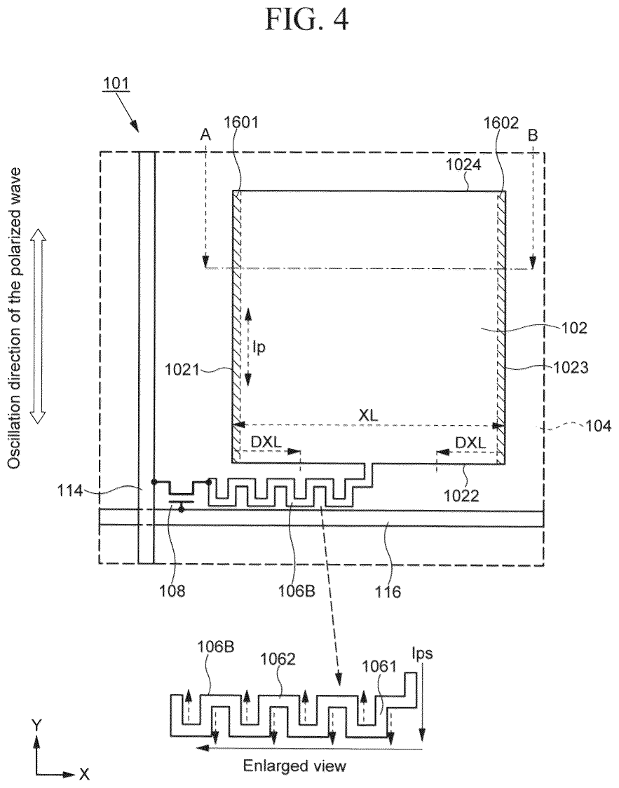

FIG. 4 shows a mode in which a strip wiring 106B having a meander pattern is connected to the patch electrode 102. That is, the strip wiring 106B has a structure in which a portion corresponding to the first linear portion 1061 consists of a plurality of first linear portions 1061 and a portion corresponding to the second linear portion 1062 consists of a plurality of second linear portions 1062, and these portions are arranged alternately. The length of the strip wiring 106 is preferably ½ or ¼ times the wavelength of the reflected radio wave. As shown in FIG. 4, since the strip wiring 106B has a meander pattern, the wiring length can be freely adjusted within a limited area.

The strip wiring 106B as shown in FIG. 4 can also be applied to the unit cell 101 shown in FIG. 2 and FIG. 3.

FIG. 5 shows the intelligent reflecting surface 100 in which the unit cells 101 are arranged in a matrix in the first direction and the second direction. The intelligent reflecting surface 100 includes the first substrate 150 arranged with the patch electrodes 102 and the second substrate 152 arranged with the counter electrode 104 and has a structure in which the first substrate 150 and the second substrate 152 are arranged to face each other and the liquid crystal layer 110 (not shown) is arranged therebetween. The first substrate 150 is arranged with a transistor 108, the control signal lines 114, and the selection signal lines 116. The control signal lines 114 and the selection signal lines 116 are arranged to intersect each other across an insulating layer (not shown), and the transistors 108 are arranged at the intersections. The first substrate 150 and the second substrate 152 are attached to each other by a sealing material arranged to surround a region in which a plurality of patch electrodes 102 are arranged. The liquid crystal layer 110 (not shown) is sealed in a region surrounded by the sealing material 118.

The intelligent reflecting surface 100 has a radio wave reflective surface 120. The radio wave reflective surface 120 has a structure in which a plurality of patch electrodes 102 are arranged on the radio wave incident side, and the counter electrode 104 is arranged on the rear surface of the plurality of patch electrodes 102 with the liquid crystal layer 110 (not shown) sandwiched therebetween. The first substrate 150 is arranged with a first driving circuit 122, a second driving circuit 124, and a terminal portion 126 in a region outside the reflective surface 120. The first driving circuit 122 outputs a selection signal to the selection signal lines 116, and the second driving circuit 124 outputs a control signal to the control signal lines 114. The terminal portion 126 is a region for forming a connection with an external circuit, and a plurality of terminal electrodes 127 are arranged along an end portion of the first substrate 150. A flexible printed circuit board (not shown) is connected to the terminal portion 126, and signals and power for driving the first driving circuit 122 and the second driving circuit 124 are input from an external circuit.

The patch electrode 102 is electrically connected to the transistor 108 by the strip wiring 106. The connection between the patch electrode 102 and the strip wiring 106 is similar to the configuration shown in FIG. 1A. The strip wiring 106B as shown in FIG. 4 can also be applied to the unit cell 101 shown in FIG. 2 and FIG. 3. The switching of the transistor 108 is controlled by a selection signal applied to the selection signal line 116. When the transistor 108 is turned on, a voltage based on the control signal is applied from the control signal line 114 to the patch electrode 102. Voltages based on control signals are individually applied to the plurality of patch electrodes 102 via the transistors 108.

It is possible to control the orientation state of the liquid crystal for each unit cell 101 forming the reflective surface 120 by applying a voltage based on a predetermined control signal to each of the plurality of patch electrodes 102. As a result, the radio waves (linearly polarized waves) incident on the reflective surface 120 can be reflected in the left-right direction in the drawing with the reflection axis VR located in the same direction as the first direction (in other words, parallel or substantially parallel directions) as the center, and can also be reflected vertically in the drawing with the reflection axis HR located in the same direction as the second direction (in other words, parallel or substantially parallel directions) as the center. That is, since the intelligent reflecting surface 100 has the reflection axis VR in the same direction as the first direction (in other words, parallel or substantially parallel directions) and the reflection axis VH in the same direction as the second direction (in other words, parallel or substantially parallel directions), the reflection angle can be controlled in the direction in which the reflection axis VR is the rotation axis, the direction in which the reflection axis HR is the rotation axis, and in the oblique direction in which these are combined.

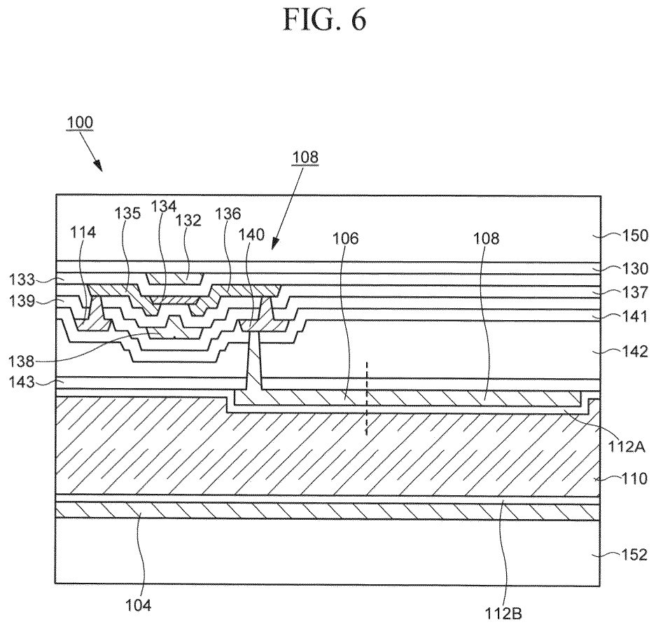

FIG. 6 shows an example of the cross-sectional structure of the intelligent reflecting surface 100 in which the transistor 108 is connected to the patch electrode 102. The transistor 108 and the patch electrode 102 are arranged on the first substrate 150, and the counter electrode 104 is arranged on the second substrate 152. The transistor 108 has a structure in which a first gate electrode 132, a first gate insulating layer 133, a semiconductor layer 134, a second gate insulating layer 137, and a second gate electrode 138 are laminated. An underlying insulating layer 130 may be arranged between the first gate electrode 132 and the first substrate 150. A first input/output electrode 135 and a second input/output electrode 136 in contact with the semiconductor layer 134 are arranged between the first gate insulating layer 133 and the second gate insulating layer 137.

A first interlayer insulating layer 139 is arranged to cover the transistor 108. The control signal line 114 is arranged on the first interlayer insulating layer 139. The control signal line 114 is connected to the first input/output electrode 135 by a contact hole through the first interlayer insulating layer 139 and the second gate insulating layer 137. A connection wiring 140 is arranged on the first interlayer insulating layer 139 and connected to the second input/output electrode 136. Although not shown, the first gate electrode 132 is connected to the selection signal line 116 (not shown) formed of the same conductive layer. The second gate electrode 138 is connected to the first gate electrode 132 in a region not overlapping the semiconductor layer 134.

A second interlayer insulating layer 141 is arranged to cover the control signal line 114 and the connection wiring 140. Further, a planarization layer 142 is arranged to fill the step formed by the transistor 108. A passivation layer 143 is arranged on the planarization layer 142, and the patch electrode 102 and the strip wiring 106 are arranged on the passivation layer 143. The patch electrode 102 and the strip wiring 106 are formed of the same conductive layer. FIG. 4 shows a structure in which the strip wiring 106 continues from the patch electrode 102. The strip wiring 106 extends from the patch electrode 102 toward the transistor 108 and is connected to the connection wiring 140 by a contact hole through the passivation layer 143, the planarization layer 142, and the second interlayer insulating layer 141. In other words, the strip wiring 106 is arranged on the same insulating layer as the patch electrode 102 (in the example shown in FIG. 4, the passivation layer 143) and is connected to the transistor 108 via a contact hole.

The counter electrode 104 is arranged on the second substrate 152. The first alignment film 112A is arranged on the patch electrode 102 and the strip wiring 106, and the second alignment film 112B is arranged on the counter electrode 104. The liquid crystal layer 110 is arranged between the first substrate 150 and the second substrate 152.

Each layer formed on the first substrate 150 is formed of the following materials. The underlying insulating layer 130 is formed of, for example, a silicon oxide film. The first gate insulating layer 133 and the second gate insulating layer 137 are formed of, for example, a silicon oxide film or a laminate of a silicon oxide film and a silicon nitride film. The semiconductor layer 134 is formed of a silicon semiconductor such as amorphous silicon, polycrystalline silicon, and an oxide semiconductor including metal oxides such as indium oxide, zinc oxide, and gallium oxide. The first gate electrode 132 and the second gate electrode 138 may be formed of, for example, molybdenum (Mo), tungsten (W), or an alloy thereof. The first input/output electrode 135, the second input/output electrode 136, the control signal line 114, and the connection wiring 140 are formed of a metal material such as titanium (Ti), aluminum (AI), and molybdenum (Mo). For example, they may be composed of a laminated structure of titanium (Ti)/aluminum (Al)/titanium (Ti) or a laminated structure of molybdenum (Mo)/aluminum (Al)/molybdenum (Mo). The first interlayer insulating layer 139 and the second interlayer insulating layer 141 are formed of a silicon oxide film, a silicon oxynitride film or the like, and the passivation layer 143 is formed of a silicon nitride film. The planarization layer 142 is formed of a resin material such as acrylic or polyimide. The patch electrode 102, the strip wiring 106, and the counter electrode 104 are formed of a metal film such as aluminum (Al) and copper (Cu) and a transparent conductive film such as indium tin oxide (ITO).

As shown in FIG. 6, by applying a selection signal to the first gate electrode 132 and the second gate electrode 138 to turn on the transistor 108, the control signal line 114 and the patch electrode 102 can be conducted via the transistor 108. When a voltage based on a control signal is applied from the control signal line 114 to the patch electrode 102, the orientation state of the liquid crystal molecules in the liquid crystal layer 110 can be controlled. As a result, the dielectric constant of the liquid crystal layer 110 in the region sandwiched between the patch electrode 102 and the counter electrode 104 can be changed, and the phase of the reflected wave with respect to the radio wave (linearly polarized wave) incident from the first substrate 150 side can be controlled.

As described with reference to FIG. 1A, since the strip wiring 106 is connected to one side of the patch electrode 102 and has the first linear portion 1061 and the second linear portion 1062, it is possible to prevent the current generated on the side of the patch electrode 102 in the same direction as the oscillation direction of the linearly polarized wave (in other words, in a parallel or substantially parallel direction) from flowing into the transistor 108 as it is, thereby preventing the attenuation of the reflected wave.

As described above, the intelligent reflecting surface 100 according to an embodiment of the present invention includes a reflective surface 120 in which a plurality of patch electrodes 102 are arrayed, and each patch electrode 102 is configured so that a current generated by polarized waves does not directly flow into the strip wiring 106. Therefore, the difference between the polarization direction (main polarized wave) of the radio wave and the polarized wave (cross polarized wave) intersecting the main polarized wave can be increased, and good reflection characteristics can be obtained. Due to these characteristics, even when a plurality of intelligent reflecting surfaces 100 are assembled to form a transmission path in the air, attenuation of polarized waves can be prevented, and communication equipment can perform excellent communication.

In the present embodiment, the case where the intelligent reflecting surface 100 reflects linearly polarized waves (vertically polarized wave, horizontally polarized wave) is described, but the same effect as described above can be obtained even when the intelligent reflecting surface 100 reflects circularly polarized waves.

It should be noted that various configurations of the intelligent reflecting surface illustrated as an embodiment of the present invention may be suitably combined as long as they are not mutually inconsistent. The addition, deletion, or design modification of components, or addition, omission, or condition modification of steps, as appropriate, by a person skilled in the art based on the intelligent reflecting surface disclosed herein and in the drawings are also within the scope of the present invention as long as they have the gist of the present invention.

Other advantageous effects which are different from the advantageous effects achieved by the aspects of the embodiments disclosed herein, but which are apparent from the description herein or can be easily predicted by a person skilled in the art, will naturally be taken to be provided by the invention.

What is claimed is:

1. An intelligent reflecting surface comprising:
a first substrate including a patch electrode, a strip wiring connected to the patch electrode, and a transistor electrically connected to the strip wiring;
a second substrate including a counter electrode opposite the patch electrode; and
a liquid crystal layer between the first substrate and the second substrate,
wherein the strip wiring includes a first linear portion in the same direction as an oscillation direction of a polarized wave incident on the patch electrode, and a second linear portion intersecting the oscillation direction of the polarized wave.

2. The intelligent reflecting surface according to claim 1, wherein the patch electrode includes a first side extending in a first direction and a second side extending in a second direction intersecting the first direction, and
the oscillation direction of the polarized wave is parallel to or in a direction equivalent to the first direction,
wherein the strip wiring is connected to the second side.

3. The intelligent reflecting surface according to claim 1, wherein the first linear portion of the strip wiring extends in a direction parallel to or equivalent to the first direction, and the second linear portion of the strip wiring extends in a direction parallel to or equivalent to the second direction,
wherein a length of the second linear portion is longer than a length of the first linear portion.

4. The intelligent reflecting surface according to claim 3, wherein the first linear portion comprises a plurality of first linear portions, and the second linear portion comprises a plurality of second linear portions,
wherein the strip wiring has a meander pattern.

5. The intelligent reflecting surface according to claim 1, wherein the patch electrode includes a first side extending in the first direction and a second side extending in the second direction intersecting the first direction, and
the oscillation direction of the polarized wave is parallel to or in a direction equivalent to the first direction,
wherein the strip wiring is connected to the first side.

6. The intelligent reflecting surface according to claim 5, wherein the first linear portion of the strip wiring extends in a direction parallel to or equivalent to the second direction, and the second linear portion of the strip wiring extends in a direction parallel to or equivalent to the first direction,
wherein a length of the second linear portion is longer than a length of the first linear portion.

7. The intelligent reflecting surface according to claim 6, wherein the first linear portion comprises a plurality of first linear portions, and the second linear portion comprises a plurality of second linear portions,
wherein the strip wiring has a meander pattern.

8. The intelligent reflecting surface according to claim 1, wherein the strip wiring and the patch electrode are arranged on an insulating layer, and
the strip wiring is electrically connected to the transistor via a contact hole arranged in the insulating layer.

9. The intelligent reflecting surface according to claim 2, wherein a length of the second side is L, and the strip wiring is connected to the patch electrode at a position closer to a center of the second side than a length of L/4 from both ends of the second side.

10. The intelligent reflecting surface according to claim 5, wherein a length of the first side is L, and the strip wiring is connected to the patch electrode at a position closer to a center of the first side than a length of L/4 from both ends of the first side.

11. The intelligent reflecting surface according to claim 1, further comprising a plurality of control signal lines extending in the first direction and a plurality of selection signal lines extending in the second direction,
wherein a set of the patch electrode, the strip wiring, and the transistor is arranged in a matrix, and
each transistor of the set is connected to any one of the plurality of control signal lines and the plurality of select signal lines.
